(19) United States
(12) Patent Application Publication
(10) Pub. No.: US 2025/0200378 A1
(43) Pub. Date: Jun. 19, 2025

(54) DOMAIN ADAPTATION OF ARTIFICIAL INTELLIGENCE MODELS BASED ON MULTI-SOURCE TIME-SERIES DATA

(71) Applicant: NEC Laboratories America, Inc., Princeton, NJ (US)

(72) Inventors: Junxiang Wang, Plainsboro, NJ (US); Wei Cheng, Princeton Junction, NJ (US); Haifeng Chen, West Windsor, NJ (US)

(21) Appl. No.: 18/980,797

(22) Filed: Dec. 13, 2024

Related U.S. Application Data
(60) Provisional application No. 63/611,417, filed on Dec. 18, 2023.

(51) Int. Cl. G06N 3/091

(52) U.S. Cl. CPC G06N 3/091

(57) ABSTRACT

Systems and methods for domain adaptation of artificial intelligence (AI) models based on multi-source time-series data. Meta-data information from tuples of time-series data and corresponding labels for the time-series data can be learned based on a fidelity loss with a prompt-based deep learning model (POND) using determined soft prompts. Mutual information from the meta-data information can be minimized by minimizing a discrimination loss of domain-specific information from the meta-data information. A common prompt can be learned with a learning objective that combines a training loss, the fidelity loss and the discrimination loss. AI models can be adapted to perform downstream tasks for different domains by utilizing the common prompt for the AI models.

### RELATED APPLICATION INFORMATION

This application claims priority to U.S. Provisional App. No. 63/611,417, filed on Dec. 18, 2023, incorporated herein by reference in its entirety.

### BACKGROUND

### Technical Field

The present invention relates to optimizing artificial intelligence (AI) models and more particularly to domain adaptation of AI models based on multi-source time-series data.

### Description of the Related Art

Artificial intelligence (AI) models have improved dramatically over the years especially in entity detection, scene reconstruction, trajectory generation, and scene understanding. However, the accuracy of the AI models are directly proportional to the quality of data that they are trained with. A minor difference in obtaining the training dataset can have a major impact on the quality of training as AI models would treat such training dataset as a different domain. Circumstances surrounding how such data is obtained also affects the quality of data within the training dataset.

### SUMMARY

According to an aspect of the present invention, a computer-implemented method is provided, including, learning meta-data information from tuples of time-series data and corresponding labels for the time-series data based on a fidelity loss with a prompt-based deep learning (POND) model using determined soft prompts, minimizing mutual information from the meta-data information by minimizing a discrimination loss of domain-specific information from the meta-data information, learning a common prompt with a learning objective that combines a training loss, the fidelity loss and the discrimination loss, and adapting artificial intelligence (AI) models to perform downstream tasks for different domains by utilizing the common prompt for the AI models.

According to another aspect of the present invention, a system including, a memory device, one or more processor devices operatively coupled with the memory device to perform operations having, learning meta-data information from tuples of time-series data and corresponding labels for the time-series data based on a fidelity loss with a prompt-based deep learning (POND) model using determined soft prompts, minimizing mutual information from the meta-data information by minimizing a discrimination loss of domain-specific information from the meta-data information, learning a common prompt with a learning objective that combines a training loss, the fidelity loss and the discrimination loss, and adapting artificial intelligence (AI) models to perform downstream tasks for different domains by utilizing the common prompt for the AI models.

According to yet another aspect of the present invention, a non-transitory computer program product is provided including a computer readable storage medium including program code for domain adaptation of artificial intelligence (AI) models based on multi-source time-series data, wherein the program code when executed on a computer causes the computer to perform operations having, learning meta-data information from tuples of time-series data and corresponding labels for the time-series data based on a fidelity loss with a prompt-based deep learning (POND) model using determined soft prompts, minimizing mutual information from the meta-data information by minimizing a discrimination loss of domain-specific information from the meta-data information, learning a common prompt with a learning objective that combines a training loss, the fidelity loss and the discrimination loss, and adapting AI models to perform downstream tasks for different domains by utilizing the common prompt for the AI models.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a flow diagram illustrating a high-level overview of a computer-implemented method for domain adaptation of AI models based on multi-source time-series data, in accordance with an embodiment of the present invention;

FIG. 2 is a block diagram showing a system of a prompt-based deep learning (POND) model, in accordance with an embodiment of the present invention.

FIG. 3 is a block diagram showing a system implementing domain adaptation of AI models based on multi-source time-series data in a healthcare setting, in accordance with an embodiment of the present invention;

FIG. 4 is a block diagram showing a computing device for domain adaptation of AI models based on multi-source time-series data, in accordance with an embodiment of the present invention; and

FIG. 5 is a block diagram showing a structure of deep neural networks for domain adaptation of AI models based on multi-source time-series data, in accordance with an embodiment of the present invention.

### DETAILED DESCRIPTION OF PREFERRED EMBODIMENTS

In accordance with embodiments of the present invention, systems and methods are provided for domain adaptation of artificial intelligence (AI) models based on multi-source time-series data.

In an embodiment, meta-data information from tuples of time-series data and corresponding labels for the time-series data can be learned based on a fidelity loss with a prompt-based deep learning model (POND) using determined soft prompts. Mutual information from the meta-data information can be minimized by minimizing a discrimination loss of domain-specific information from the meta-data information. A common prompt can be learned with a learning objective that combines a training loss, the fidelity loss and the discrimination loss. AI models can be adapted to perform downstream tasks for different domains by utilizing the common prompt for the AI models.

Due to the widespread availability of time-series sensor data, the application of time-series prediction tasks has extended to diverse real-world domains, including human activity recognition, sleep stage classification, and machine fault diagnosis. However, the labeling of time-series sensor data is often costly or impractical. This challenge has led researchers to explore domain adaptation techniques, leveraging labeled time-series data from related sources to train models and transfer knowledge to the target domain.

The time-series domain adaptation problem is particularly formidable due to complex dynamic patterns, distribution shifts, and potential label shifts. This challenge has prompted extensive investigation, resulting in various methods like kernel matching, context information alignment, and temporal-spectral fusion. While existing approaches primarily focus on knowledge transfer from a single source domain, the case involving multiple source domains remains underexplored. Learning common feature representations can overlook domain-specific time-series representations which affects improved domain adaptation.

Performing multiple source time-series domain adaptation can have at least the following challenges:

Lack of quantitative relationship between meta-data and time-series distributions. Understanding the distribution of a time-series domain often involves meta-data information, whether visible (e.g., sensor settings) or invisible (e.g., signal characteristics due to cable connections). However, the quantitative relationship between meta-data and time-series distributions is typically unknown.

Insufficient exploration of domain-specific meta-data information. Current methods often focus on common time-series representations which neglects domain-specific nuances that affects accurate classification. Temporal patterns, contextual information, or sensor characteristics in distinct domains are often overlooked, limiting the model's ability to capture differences and hindering real-world performance.

The present embodiments can address the challenges described herein by employing a prompt-based deep learning (POND) model that can learn the meta-data information for multi-source time-series data by performing meta-learning using expert networks. By doing so, the present embodiments improve accuracy and efficiency of the AI models due to their understanding of the meta-data information.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

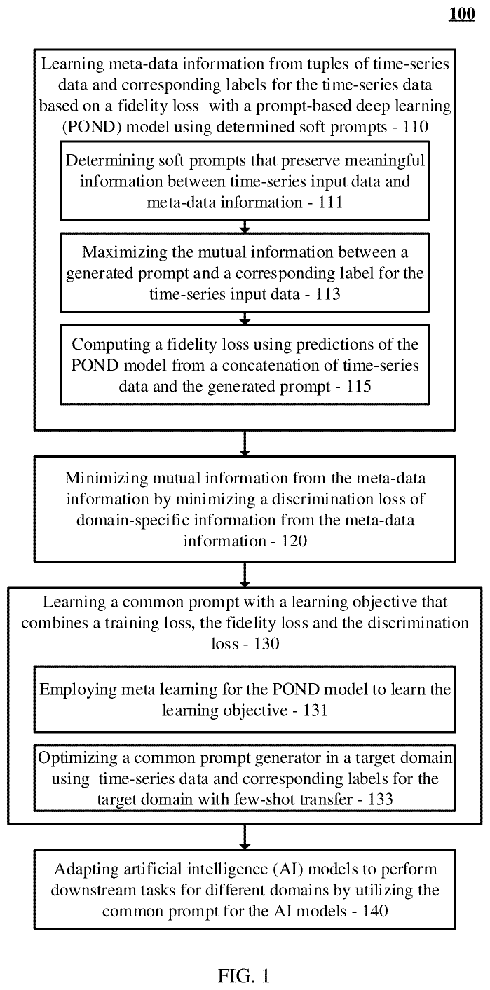

Referring now in detail to the figures in which like numerals represent the same or similar elements and initially to FIG. 1, a high-level overview of a computer-implemented method for domain adaptation of AI models based on multi-source time-series data is illustratively depicted in accordance with one embodiment of the present invention.

In an embodiment, meta-data information from tuples of time-series data and corresponding labels for the time-series data can be learned based on a fidelity loss with a prompt-based deep learning model (POND) using determined soft prompts. Mutual information from the meta-data information can be minimized by minimizing a discrimination loss of domain-specific information from the meta-data information. A common prompt can be learned with a learning objective that combines a training loss, the fidelity loss and the discrimination loss. AI models can be adapted to perform downstream tasks for different domains by utilizing the common prompt for the AI models.

In block 110, meta-data information from tuples of time-series data and corresponding labels for the time-series data can be learned based on a fidelity loss with a prompt-based deep learning model (POND) using determined soft prompts.

Meta-data information can include information that are relevant to time-series data and are common to a certain type of time-series data. For example, in time-series data collected using sensors, sensor information such as sensor settings, type of sensor, and circumstances under which the sensor was used can be meta-data information.

Time-series data can be obtained from multiple sources such as sensors (e.g., camera, radio detection and ranging (RADAR), light detection and ranging (LIDAR), ultrasounds, electrocardiograms, etc.) to measure an entity (e.g., patient in healthcare, profits, autonomous vehicle, etc.). For example, time-series data for healthcare data can include pulse rate, oxygen saturation, electrocardiogram data, endoscopic image data, etc. Even when measuring the same time-series data for the same entity, characteristics of the data and the data interval for the time-series data can differ depending on the meta-data information such as type of sensor, settings of the sensor, and circumstances under which the data was acquired (e.g., temperature, experience of the healthcare professional using the sensor, etc.).

The corresponding labels for the time-series data can be a representation of the state of the entity. For example, a patient condition which can represent whether the patient is in a normal state or in an abnormal state (e.g., blood glucose levels for diabetes, endoscopic image data for detecting tumors). The labeled data can be used, for example, to train an AI model to detect abnormal conditions in patients.

To learn meta-data information, AI models can be fine-tuned by prompt tuning using tuples of time-series data and corresponding labels to determine soft prompts using the POND model. The tuples of time-series data and corresponding labels can be obtained from domain-specific datasets. In another embodiment, the time-series data can be labeled by a pre-trained AI model such as large language models (e.g., ChatGPT™, etc.).

Prompt tuning involves modulating the behaviors of pretrained models with text prompts (e.g., task descriptions). Despite the effectiveness of text prompts, they involve human efforts and are limited by the fitness of model input. Prompt tuning addresses these issues by making text prompts learnable through generated soft prompts by a prompt generator. The soft prompts can be concatenated to different model inputs as a prefix to learn specific information for a downstream task.

Meta-data information α^{(S}^{ᵢ}⁾, controlling time-series distributions p(X; α^{(S}^{ᵢ}⁾) can be affected by numerous factors, which is not flexible enough for the soft prompt to learn. For example, the characteristics of optical signals are affected by the plug-in action of the fiber cable into the network transponder, determined by uncontrollable factors such as misalignment of connectors, contaminants on the connectors, and excessive force on fiber. To tackle this, in addition to the soft prompt P∈ [symbol] ^{m×n}, where m is the prompt length, n is the number of domains, the present embodiments can adapt a prompt generator g^{(s}^{ᵢ}⁾, parameterized by a neural network, to learn meta-data information.

Specifically, ΔP^{(s}^{ᵢ}⁾=g^{(s}^{ᵢ}⁾(Xⱼ^{(s}^{ᵢ}⁾)∈ [symbol] ^{m×n}, where ΔPⱼ^{(s}^{ⱼ}⁾ is the instance-level prompt of Xⱼ^{(s}^{ᵢ}⁾, and m<<L suggests that the prompt generator g^{(s}^{ᵢ}⁾ compresses the long time-series input Xⱼ^{(s}^{ᵢ}⁾ into a short instance-level prompt ΔPⱼ^{(s}^{ᵢ}⁾. For any time-series input Xⱼ^{(s}^{ᵢ}⁾, a corresponding prompt can be used to learn the meta-data information. The corresponding prompt can include a concatenated soft prompt P and an instance-level prompt ΔPⱼ^{(s}^{ᵢ}⁾ (e.g., P+ΔPⱼ^{(s}^{ᵢ}⁾ can be used to learn the meta-data information. In another embodiment, the instance level prompt can be generated from time series data and a random variable from the same domain.

In block 111, soft prompts can be determined that preserve meaningful information between time-series input data and meta-data information.

In other words, ΔPⱼ^{(s}^{ᵢ}⁾ can preserve as much meaningful information as possible, which can be provided by the label information Yⱼ^{(s}^{ᵢ}⁾.

In block 113, soft prompts can be determined by maximizing the mutual information between a generated prompt and a corresponding label for the time-series input data. To do so, the mutual information between ΔPⱼ^{(s}^{ᵢ}⁾ and Yⱼ^{(s}^{ᵢ}⁾ can be maximized with the following equation:

min Σᵢ₌₁^{M}Σⱼ₌₁^{|S}^{ᵢ}^{|}−MI(ΔPⱼ^{(S}^{ᵢ}⁾, Yⱼ^{(S}^{ᵢ}⁾, where MI(⋅, ⋅) is the mutual information operator which is performed with:

MI(ΔPⱼ^{(s}^{ᵢ}⁾, Yⱼ^{(s}^{ᵢ}⁾=H(Yⱼ^{(s}^{ᵢ}⁾−H(Yⱼ^{(s}^{ᵢ}⁾|ΔPⱼ^{(s}^{ᵢ}⁾), where H(Yⱼ^{(s}^{ᵢ}⁾) is the Shannon entropy of Yⱼ^{(S}^{ᵢ}⁾, and H(Yⱼ^{(S}^{ᵢ}⁾|ΔPⱼ^{(S}^{ᵢ}⁾) is the Shannon entropy of Yⱼ^{(S}^{ᵢ}⁾ conditioned on ΔPⱼ^{(S}^{ᵢ}⁾.

Maximizing the mutual information between ΔPⱼ^{(S}^{ᵢ}⁾ and Yⱼ^{(S}^{ᵢ}⁾ is equivalent to minimizing the conditional entropy H(Yⱼ^{(S}^{ᵢ}⁾|ΔPⱼ^{(S}^{ᵢ}⁾): min Σᵢ₌₁^{M}Σⱼ₌₁^{|S}^{ᵢ}^{|}H(Yⱼ^{(S}^{ᵢ}⁾|ΔPⱼ^{(S}^{ᵢ}⁾).

The conditional entropy H(Yⱼ^{(S}^{ᵢ}⁾|ΔPⱼ^{(S}^{ᵢ}⁾) can be approximated by the cross-entropy between f([ΔPⱼ^{(S}^{ᵢ}⁾, Xⱼ^{(S}^{ᵢ}⁾]) and Yⱼ^{(S}^{ᵢ}⁾, where f([ΔPⱼ^{(S}^{ᵢ}⁾, Xⱼ^{(S}^{ᵢ}⁾]) is the prediction of the POND model with the concatenation of instance-level prompt ΔPⱼ^{(S}^{ᵢ}⁾ and time-series data Xⱼ^{(S}^{ᵢ}⁾ as an input.

In block 115, a fidelity loss can be computed using predictions of the POND model from a concatenation of time-series data and the generated prompt. To optimize the prompt generator g^{(S}^{ᵢ}⁾ a fidelity loss can be computed. The fidelity loss can measure whether the generated prompt ΔPⱼ^{(S}^{ᵢ}⁾ truly represents the distribution p(X; α^{(S}^{ᵢ}⁾). The fidelity loss (l_{F}) can then be computed as: l_{F}=Σᵢ₌₁^{M}Σⱼ₌₁^{|S}^{ᵢ}^{|}Yⱼ^{(S}^{ᵢ}⁾ log f([ΔPⱼ^{(S}^{ᵢ}⁾, Xⱼ^{(S}^{ᵢ}⁾]).

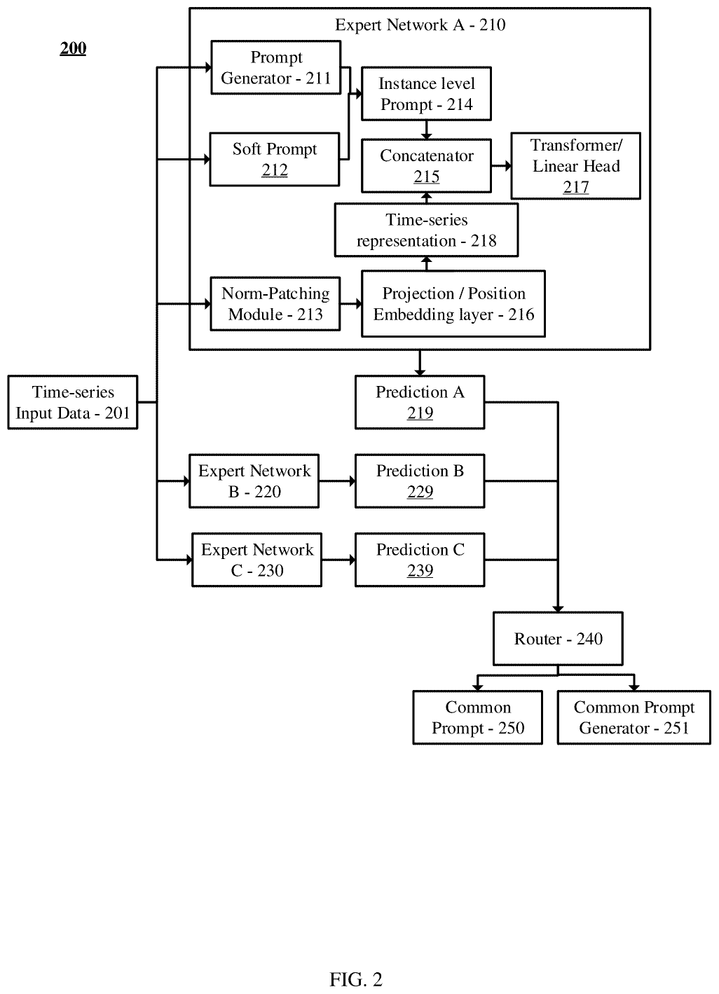

The structure of the POND model is shown in FIG. 2.

Referring now to FIG. 2, a block diagram showing a system of a prompt-based deep learning (POND) model, in accordance with an embodiment of the present invention.

The POND model 200 can include expert networks (e.g., expert network A 210, expert network B 220, expert network C 230) that can take time-series input data 201 from different domains and generate predictions (e.g., prediction A 219, prediction B 229, prediction C 239). The predictions can include the learned classification labels of the expert networks for the time-series input data 201 and the corresponding prompts to generate the predictions.

The POND model 200 can include a router 240, responsible for learning probability distributions over all predictions, and can be implemented as a linear model. To do so, the router 240 obtains the weight vector Wₖ ε [symbol] ^{L} for the k-th expert network, where L is the number of experts, then the router 240 uses the following equations:

$${h}_{k} ( {X}_{j}^{( {S}_{i} )} ) = {w}_{k} {X}_{j}^{( {S}_{i} )}$$

$${p}_{k} ( {X}_{j}^{( {S}_{i} )} ) = \frac{{h}_{k} ( {x}_{j}^{( {S}_{i} )} )}{{\sum }_{k = 1}^{K} {h}_{k} ( {X}_{j}^{( {S}_{i} )} )}$$

where hₖ is the logit for the k-th expert, and pₖ is the probability for the k-th expert, Sᵢ is an element of the domains, j is an element of the time-series data. The overall output of the POND model 200 can be a linear combination of predictions (e.g., prediction A 219, prediction B 229, prediction C 239) over all expert networks, as shown below: γ=Σₖ₌₁^{K}Σₖ(Xⱼ^{(S}^{ᵢ}⁾Pₖ(Xⱼ^{(S}^{ᵢ}⁾), where Ek is the output of the k-th expert network. The combination of predictions can then be represented as a common prompt 250 which can be used for few-shot transfer to other AI models for different domains. The router 240 can also learn to update the prompt generators 211 to generate a common prompt generator 251 using meta-learning. In another embodiment, the router 240 can employ a neural network that learns the probability and logits of the expert networks and outputs a combination of the probability and logits of the expert networks. The prompt generator 211 can include a neural network (e.g., recurrent neural network, transformer models, etc.) that can be trained to generate text such as prompts, soft prompts, etc.

The expert networks (e.g., expert network A 210, expert network B 220, expert network C 230) can include same configuration. The configuration can include a transformer/linear head 217 having a transformer-based model and a linear head, a prompt generator 211, a norm-patching module 213, a projection/position embedding layer 216, and a concatenator 215. The input of the transformer/linear head 217 is a concatenation of two components the time-series representation 218 and an instance level prompt 214. The concatenation is performed by the concatenator 215.

To generate the instance-level prompt 214, a soft prompt 212 and the time-series input data 201 is processed by the prompt generator 211. The soft prompt 212 can include text that can be concatenated to different model inputs as a prefix to learn specific information for the current domain processed by the expert network for a downstream task.

To generate the time-series representation 218, a norm-patching module 213 can perform patching (e.g., aggregating point-wise time steps into subseries-level patches) to capture local semantic information from the time-series input data 201 and instance normalization to mitigate the distribution shift between training and test data from the time-series input data 201. The time-series representation 218 is encoded after passing time-series patches into a projection/position embedding layer 216 that includes a projection layer and a position embedding layer. In another embodiment, the expert networks can have different configurations (e.g., multiple transformer models, multiple projection/position embedding layers, etc.).

Each expert networks can be pretrained independently with the time-series input data 201. The router 240 can be trained with training data obtained from the domain-specific time-series data to generate classification labels for the domain-specific time-series data, and while expert architectures are frozen. The router 240 can include neural networks such as long short-term memory, recurrent neural networks, etc.

The common prompt 250 and the prompt generator 211 of source domains g^{(S}^{ᵢ}⁾ are optimized with the fidelity loss to obtain a common prompt generator 251. The prompt generator 211 of the target domain g^{(T)} can be optimized with few-shot transfer to generate predictions in a target domain using the common prompt 250 and the common prompt generator 251. This process described in more detail in blocks 120, 130, and 140.

In another embodiment, the router 240 can learn how to compensate for biases detected within the meta-data information. For example, due to the meta-data information (e.g., wrong calibration settings of the sensor), the time-series data input is increased by 0.1. The router 240 can learn the meta-data information and also learn to compensate for the biases from the meta-data information such as updating the time-series data input to correct levels (e.g., decreasing by 0.1 due to the bias).

Referring back now to FIG. 1. In block 120, mutual information from the meta-data information can be minimized by minimizing a discrimination loss of domain-specific information from the meta-data information.

The mutual information from the meta-data information can include commonalities between the meta-data information which can include domain-specific information of meta-data α^{(S}^{ᵢ}⁾. This information not only aids in understanding the gaps between multiple time-series source domains but also in selecting suitable source time-series domains for adaptation. The instance-level prompt 214 ΔPⱼ^{(S}^{ᵢ}⁾ can be harnessed to capture such domain-specific information.

To minimize the mutual information of domain-specific prompts between different source time-series domains, the following equation can be utilized:

$$min {\sum }_{{i}_{1} \neq {i}_{2}} M I ( Δ {P}^{( {S}_{{i}_{1}} )} , Δ {P}^{( {S}_{{i}_{2}} )} ) ,$$

where ΔP^{(S}^{ᵢ₁}⁾ is the domain-specific prompt which can be computed as the mean of the instance-level prompt 214 ΔPⱼ^{(S}^{ᵢ}⁾. This equation can be formulated as a discrimination loss (l_{D}):

$${\sum }_{{i}_{1} \neq {i}_{2}} 𝔼 log \frac{exp ( s i m ( {ΔP}^{( {S}_{{i}_{1}} )} , Δ {P}^{( {S}_{{i}_{2}} )} ) )}{{\sum }_{{i}_{1} \neq {i}_{2}} exp ( sim ( Δ {P}^{( {S}_{{i}_{1}} )} , Δ {P}^{( {S}_{{i}_{2}} )} ) )}$$

where sim (⋅, ⋅) is the similarity function used to measure the similarity between two instance-level prompts 214 (e.g., inner product, cosine similarity, etc.), Si is an element of the domains. Other mutual information upper bounds can be utilized such as contrastive log-ratio bound.

In block 130, a common prompt can be learned by minimizing a training loss that combines the fidelity loss and the discrimination loss.

The common prompt 250 can include a prompt that can be adapted to various downstream tasks. The common prompt 250 can include generalizations of the predictions of the various AI models that can perform the various downstream tasks. The predictions can include the labels for the time-series data in the different domains.

In block 131, meta learning can be employed for the POND model to learn a learning objective.

To learn the common prompt 250 and the parameterized common prompt generator 251, a learning objective can be employed:

min_{p,g}_{^{(si)}}F(p, g^{(S}^{ᵢ}⁾=l_{T}+λ₁l_{D}+λ₂l_{F}, where λ₁ and λ₂ are tuning parameters that control the trade-off between fidelity and discrimination. The training loss (l_{T}) can measure the performance of the fine tuning of the AI models through prompt tuning. The training loss can be calculated as:

$${l}_{T} = \frac{1}{M} {\sum }_{i = 1}^{M} \frac{1}{\vert {S}_{i} \vert} {\sum }_{j = 1}^{\vert {S}_{i} \vert} {Y}_{j}^{( {S}_{i} )} R ( f ( [ P + Δ {P}_{j}^{( {S}_{i} )} , {X}_{j}^{( {S}_{i} )} ] ) , {Y}_{j}^{( {S}_{i} )} ) ,$$

where R( ) is the loss function (e.g., cross-entropy loss), [P+ΔPⱼ^{(S}^{ᵢ₎}, Xⱼ^{(S}^{ᵢ}⁾] is the concatenation of the domain-level prompt (e.g., processed generated prompt and instance-level prompt 214) and the time-series input.

The learning objective can be learned through meta-learning methods such as the Reptile algorithm. The Reptile algorithm conducts standard steps of gradient descent without the need for calculating second derivatives.

This is shown in more detail in the Algorithm:

Input: (Xⱼ^{(S}^{ᵢ}⁾, Yⱼ^{(S}^{ᵢ}⁾, the global learning rate ε∈(0, 1], the local learning rate η >0, the number of global steps N. Output: the common prompt P 250, the common prompt generator g^{(S}^{_{T}}⁾ 251.
1: for i=1 to N do
2: Randomly pick a source time-series domain S_{τ}.
3: g(Sτ)←g(Sτ)−n∇g^{(S}^{_{τ}}⁾F.
4: Q←P−n∇P l_{T}.
5: P←P+ε(Q−P).
6: end for

In block 133, the common prompt generator can be optimized in a target domain using time-series data and corresponding labels for the target domain with few-shot transfer.

The common prompt generator 251 can be optimized in a target domain (T_{D}) with few-shot transfer as follows:

$${min}_{{g}^{( {T}_{D} )}} \frac{1}{\vert {T}_{D} \vert} R ( f ( [ P + Δ {P}_{\dot{j}}^{( {T}_{D} )} , {X}_{\dot{j}}^{( {T}_{D} )} ] ) , {Y}_{\dot{j}}^{( {T}_{D} )} ) .$$

To select the most similar source domain for transfer, a clustering algorithm e.g., nearest neighbor rule can be used. In another embodiment, k-means clustering can be used.

In block 140, the AI models can be adapted to perform downstream tasks for different domains by utilizing the common prompt for the AI models.

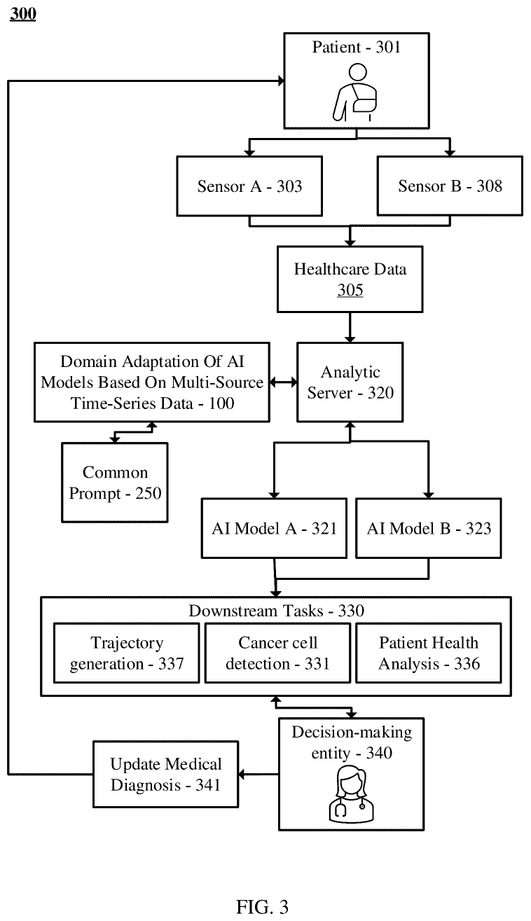

Multiple AI models can be adapted to different domains to perform various downstream tasks by utilizing the common prompt 250 to the AI models. For example, an AI model for trajectory generation based on time-series data obtained from camera sensors on an autonomous vehicle can employ the common prompt 250 to understand the meta-data information between the camera sensors and improve accuracy of the AI model. The trajectory generated can be used to control the autonomous vehicle. In another example, an AI model for updating medical diagnosis based on time-series data obtained from medical sensors to obtain healthcare data from a patient can employ the common prompt 250 to understand the meta-data information between the medical sensors to improve accuracy of the AI model. This is shown in more detail in FIG. 3.

Other downstream tasks can be performed such as machine fault diagnosis (e.g., determining anomalies within the performance of a machine and performing a corrective action such as halting the machine, etc.), sleep stage classification, human activity recognition, etc.

Referring now to FIG. 3, a block diagram showing a system implementing domain adaptation of AI models based on multi-source time-series data in a healthcare setting, in accordance with an embodiment of the present invention.

In system 300, a patient 301 can be admitted to a hospital where sensors can collect healthcare data. Sensor A 303 can collect healthcare data 305. Sensor A 303 can include an electrocardiogram (ECG), glucose meter, sphygmomanometer, pulse oximeter, etc. Healthcare data 305 can include ECG data, glucose levels, blood pressure, blood oxygen levels. Sensor B 308 can also collect the same healthcare data 305 but can have a different meta-data information from sensor A 303 such as different manufacturers, different healthcare data management systems, or a different health practitioner that used the sensor, etc.

The healthcare data 305 can be sent to an analytic server 320 that implements the domain adaptation of AI models based on multi-source time-series data 100 which outputs a common prompt 250. The common prompt 250 can be employed to different AI models that can perform different downstream tasks 330. For example, AI model A 321 is trained to perform cancer cell detection 331 and AI model B 323 is trained to perform patient health analysis 336. Both downstream tasks 330 can use healthcare data 305 but in a different way. For example, healthcare data 305 can include blood glucose levels which can be used as additional information for cancer cell detection 331, but is used as a major determining factor in patient health analysis 336 (e.g., diabetes detection). The output of AI model A 321 and AI model B 323 can include a label representing the condition of patient 301 whether patient 301 is in a normal state (e.g., benign or healthy) or an abnormal state (e.g., cancer or diabetes).

The output of AI model A 321 and AI model B 323 (e.g., proposed updated medical diagnosis) can be shown to a decision-making entity 340 (e.g., health practitioner, nurse, doctor, etc.) and assist their decision-making process to perform update medical diagnosis 341 which includes the label representing the condition of patient 301 which can be sent to the patient 301. Because of the common prompt 250, AI model A 321 and AI model B 323 have meta-data information regarding sensor A 303 and sensor B 308 which increases the accuracy of the output (e.g., prediction, classification, etc.) of both AI model A 321 and AI model B 323 at least because biases stemming from the meta-data information can be removed or minimized.

In another embodiment, the AI models can perform trajectory generation 337 for an autonomous vehicle using time-series data obtained from sensors on the autonomous vehicle. In another embodiment, the sensors are not directly installed on the autonomous vehicle.

The present embodiments address the challenges described herein by employing a prompt-based deep learning (POND) model that can learn the meta-data information for multi-source time-series data by performing meta-learning using expert networks. By doing so, the present embodiments improve accuracy and efficiency of the AI models due to their understanding of the meta-data information. Additionally, AI models can be trained faster and with less resources due to the understanding of the meta-data information.

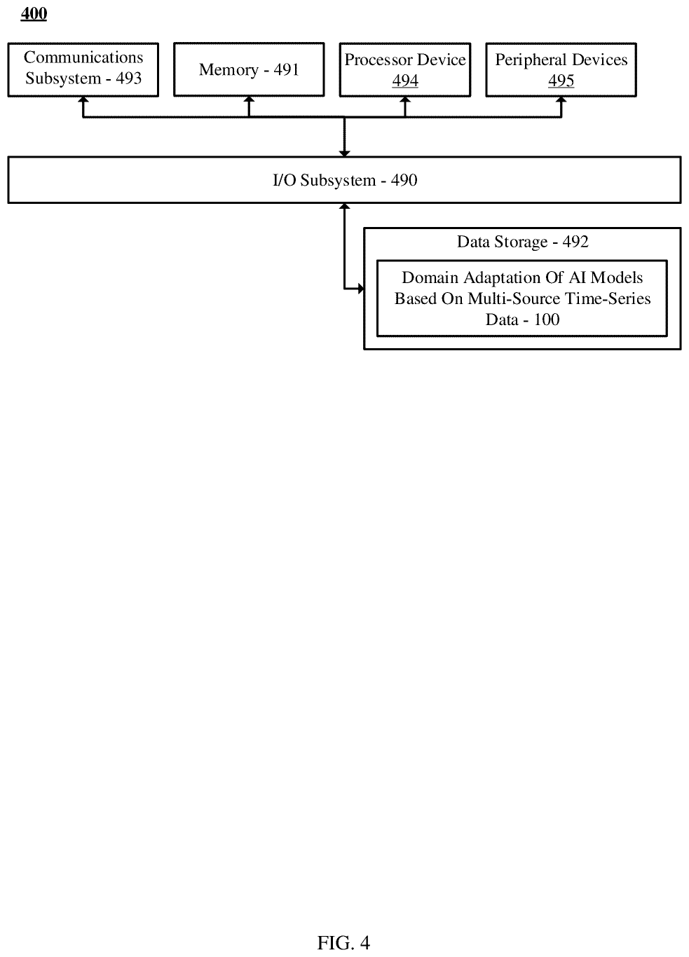

Referring now to FIG. 4, a block diagram showing a computing device for domain adaptation of AI models based on multi-source time-series data, in accordance with an embodiment of the present invention.

The computing device 400 illustratively includes the processor device 494, an input/output (I/O) subsystem 490, a memory 491, a data storage device 492, and a communication subsystem 493, and/or other components and devices commonly found in a server or similar computing device. The computing device 400 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 491, or portions thereof, may be incorporated in the processor device 494 in some embodiments.

The processor device 494 may be embodied as any type of processor capable of performing the functions described herein. The processor device 494 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 491 may be embodied as any type of volatile or non-volatile memory or data storage capable of performing the functions described herein. In operation, the memory 491 may store various data and software employed during operation of the computing device 400, such as operating systems, applications, programs, libraries, and drivers. The memory 491 is communicatively coupled to the processor device 494 via the I/O subsystem 490, which may be embodied as circuitry and/or components to facilitate input/output operations with the processor device 494, the memory 491, and other components of the computing device 400. For example, the I/O subsystem 490 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 490 may form a portion of a system-on-a-chip (SOC) and be incorporated, along with the processor device 494, the memory 491, and other components of the computing device 400, on a single integrated circuit chip.

The data storage device 492 may be embodied as any type of device or devices configured for short-term or long-term storage of data such as, for example, memory devices and circuits, memory cards, hard disk drives, solid state drives, or other data storage devices. The data storage device 492 can store program code for domain adaptation of AI models based on multi-source time-series data 100. Any or all of these program code blocks may be included in a given computing system.

The communication subsystem 493 of the computing device 400 may be embodied as any network interface controller or other communication circuit, device, or collection thereof, capable of enabling communications between the computing device 400 and other remote devices over a network. The communication subsystem 493 may be configured to employ any one or more communication technology (e.g., wired or wireless communications) and associated protocols (e.g., Ethernet, InfiniBand®, Bluetooth®, Wi-Fi®, WiMAX, etc.) to affect such communication.

As shown, the computing device 400 may also include one or more peripheral devices 495. The peripheral devices 495 may include any number of additional input/output devices, interface devices, and/or other peripheral devices. For example, in some embodiments, the peripheral devices 495 may include a display, touch screen, graphics circuitry, keyboard, mouse, speaker system, microphone, network interface, and/or other input/output devices, interface devices, GPS, camera, and/or other peripheral devices.

Of course, the computing device 400 may also include other elements (not shown), as readily contemplated by one of skill in the art, as well as omit certain elements. For example, various other sensors, input devices, and/or output devices can be included in computing device 400, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing device 400 are readily contemplated by one of ordinary skill in the art given the teachings of the present invention provided herein.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

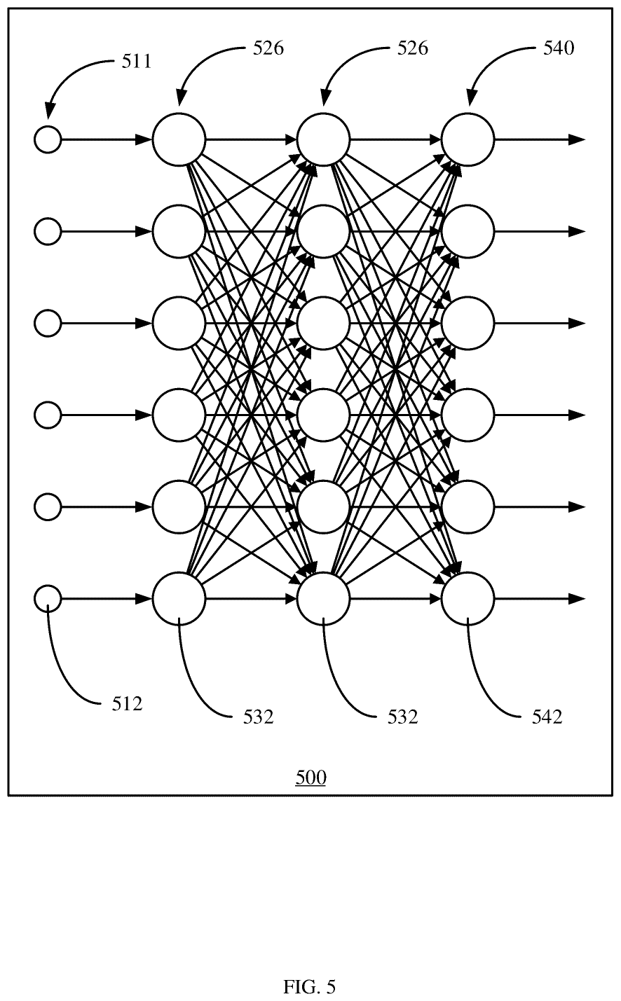

Referring now to FIG. 5, a block diagram showing a structure of deep neural networks for domain adaptation of AI models based on multi-source time-series data, in accordance with an embodiment of the present invention.

A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types and may include multiple distinct values. The network can have one input neurons for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

The deep neural network 500, such as a multilayer perceptron, can have an input layer 511 of source neurons 512, one or more computation layer(s) 526 having one or more computation neurons 532, and an output layer 540, where there is a single output neuron 542 for each possible category into which the input example could be classified. An input layer 511 can have a number of source neurons 512 equal to the number of data values 512 in the input data 511. The computation neurons 532 in the computation layer(s) 526 can also be referred to as hidden layers, because they are between the source neurons 512 and output neuron(s) 542 and are not directly observed. Each neuron 532, 542 in a computation layer generates a linear combination of weighted values from the values output from the neurons in a previous layer, and applies a non-linear activation function that is differentiable over the range of the linear combination. The weights applied to the value from each previous neuron can be denoted, for example, by w₁, w₂, . . . wₙ₋₁, wₙ. The output layer provides the overall response of the network to the inputted data. A deep neural network can be fully connected, where each neuron in a computational layer is connected to all other neurons in the previous layer, or may have other configurations of connections between layers. If links between neurons are missing, the network is referred to as partially connected.

In an embodiment, the computation layers 526 of the transformer/linear head 217 can learn relationships between the concatenated time-series representations 218 and the instance-level prompt 214 by using the concatenator 215. The output layer 540 of the transformer/linear head 217 can then provide the overall response of the network as a prediction based on the time-series input data which can be used by the router 240 to learn the common prompt 250. Additionally, the router 240 can learn the relationships between the predictions from the expert networks to generate a common prompt 250 and the common prompt generator 251. Further, the prompt generator 211 can learn the relationships between tokens within the time-series input data 201 to generate text such as prompts, soft prompts, etc. The router can also learn to compensate for biases detected from the meta-data information based on past data.

Training a deep neural network can involve two phases, a forward phase where the weights of each neuron are fixed and the input propagates through the network, and a backwards phase where an error value is propagated backwards through the network and weight values are updated. The computation neurons 532 in the one or more computation (hidden) layer(s) 526 perform a nonlinear transformation on the input data 512 that generates a feature space. The classes or categories may be more easily separated in the feature space than in the original data space.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method, comprising:
learning meta-data information from tuples of time-series data and corresponding labels for the time-series data based on a fidelity loss with a prompt-based deep learning (POND) model using determined soft prompts;
minimizing mutual information from the meta-data information by minimizing a discrimination loss of domain-specific information from the meta-data information;
learning a common prompt with a learning objective that combines a training loss, the fidelity loss and the discrimination loss; and
adapting artificial intelligence (AI) models to perform downstream tasks for different domains by utilizing the common prompt for the AI models.

2. The computer-implemented method of claim 1, wherein the downstream tasks further comprises updating a medical diagnosis of a patient from healthcare data collected as time-series data by utilizing the AI models to assist a decision-making process of a decision-making entity.

3. The computer-implemented method of claim 1 wherein learning the meta-data information further comprises determining soft prompts that preserve meaningful information between time-series input data and meta-data information.

4. The computer-implemented method of claim 3, wherein determining the soft prompts further comprises maximizing the mutual information between a generated prompt and a corresponding label for the time-series input data.

5. The computer-implemented method of claim 4, wherein learning the meta-data information further comprises computing the fidelity loss using predictions of the POND model from a concatenation of time-series data and the generated prompt.

6. The computer-implemented method of claim 1, wherein learning the common prompt further comprises optimizing a prompt generator in a target domain using time-series data and corresponding labels for the target domain with few-shot transfer.

7. The computer-implemented method of claim 1, wherein learning the common prompt further comprises employing meta learning for the POND model to learn the learning objective.

8. A system, comprising:
a memory device;
one or more processor devices operatively coupled with the memory device to perform operations including:
learning meta-data information from tuples of time-series data and corresponding labels for the time-series data based on a fidelity loss with a prompt-based deep learning (POND) model using determined soft prompts;
minimizing mutual information from the meta-data information by minimizing a discrimination loss of domain-specific information from the meta-data information;
learning a common prompt with a learning objective that combines a training loss, the fidelity loss and the discrimination loss; and
adapting artificial intelligence (AI) models to perform downstream tasks for different domains by utilizing the common prompt for the AI models.

9. The system of claim 8, wherein the downstream tasks further comprises updating a medical diagnosis of a patient from healthcare data collected as time-series data by utilizing the AI models to assist a decision-making process of a decision-making entity.

10. The system of claim 8, wherein learning the meta-data information further comprises determining soft prompts that preserve meaningful information between time-series input data and meta-data information.

11. The system of claim 10, wherein determining the soft prompts further comprises maximizing the mutual information between a generated prompt and a corresponding label for the time-series input data.

12. The system of claim 11, wherein learning the meta-data information further comprises computing the fidelity loss using predictions of the POND model from a concatenation of time-series data and the generated prompt.

13. The system of claim 8, wherein learning the common prompt further comprises optimizing a prompt generator in a target domain using time-series data and corresponding labels for the target domain with few-shot transfer.

14. The system of claim 8, wherein learning the common prompt further comprises employing meta learning for the POND model to learn the learning objective.

15. A non-transitory computer program product comprising a computer readable storage medium including program code for domain adaptation of artificial intelligence (AI) models based on multi-source time-series data, wherein the program code when executed on a computer causes the computer to perform operations having:
learning meta-data information from tuples of time-series data and corresponding labels for the time-series data based on a fidelity loss with a prompt-based deep learning (POND) model using determined soft prompts;
minimizing mutual information from the meta-data information by minimizing a discrimination loss of domain-specific information from the meta-data information;
learning a common prompt with a learning objective that combines a training loss, the fidelity loss and the discrimination loss; and
adapting AI models to perform downstream tasks for different domains by utilizing the common prompt for the AI models.

16. The non-transitory computer program product of claim 15, wherein the downstream tasks further comprises updating a medical diagnosis of a patient from healthcare data collected as time-series data by utilizing the AI models to assist a decision-making process of a decision-making entity.

17. The non-transitory computer program product of claim 15, wherein learning the meta-data information further comprises determining soft prompts that preserve meaningful information between time-series input data and meta-data information.

18. The non-transitory computer program product of claim 17, wherein determining the soft prompts further comprises maximizing the mutual information between a generated prompt and a corresponding label for the time-series input data.

19. The non-transitory computer program product of claim 18, wherein learning the meta-data information further comprises computing the fidelity loss using predictions of the POND model from a concatenation of time-series data and the generated prompt.

20. The non-transitory computer program product of claim 15, wherein learning the common prompt further comprises optimizing a prompt generator in a target domain using time-series data and corresponding labels for the target domain with few-shot transfer.
